(19) United States
(12) Patent Application Publication
(10) Pub. No.: US 2017/0002904 A1
(43) Pub. Date: Jan. 5, 2017

(54) MOTOR VEHICLE WITH AIRFOIL ASSEMBLY

(71) Applicant: Audi AG, 85045 lngolstadt (DE)

(72) Inventor: Christoph Behle, Pörnbach (DE)

(73) Assignee: Audi AG, 85045 lngolstadt (DE)

(21) Appl. No.: 15/197,044

(22) Filed: Jun. 29, 2016

(30) Foreign Application Priority Data
Jul. 1, 2015 (DE) 10 2015 008 475.5

(51) Int. Cl. F16H 19/04; F16H 7/02; B62D 35/00

(52) U.S. Cl. CPC F16H 19/04; B62D 35/007; F16H 7/02

(57) ABSTRACT

A motor vehicle includes an airfoil assembly which is arranged in a region of a rear window of the motor vehicle. The airfoil assembly includes at least one airfoil, a guide arranged on a side of the rear window, and an actuator configured to move the at least one airfoil along the guide.

### CROSS-REFERENCES TO RELATED APPLICATIONS

This application claims the priority of German Patent Application, Serial No. 10 2015 008 475.5, filed Jul. 1, 2015, pursuant to 35 U.S.C. 119(a)-(d), the disclosure of which is incorporated herein by reference in its entirety as if fully set forth herein.

### BACKGROUND OF THE INVENTION

The present invention relates to a motor vehicle with an airfoil assembly.

The following discussion of related art is provided to assist the reader in understanding the advantages of the invention, and is not to be construed as an admission that this related art is prior art to this invention.

An airfoil assembly in motor vehicles is used to improve air flow around the motor vehicle and thus aerodynamics of the motor vehicle. Aerodynamics of the motor vehicle is primarily influenced by the silhouette and attachments mounted to the motor vehicle. Apart from the impact that such airfoils have on the aerodynamics of the motor vehicle, the visual look of the motor vehicle, in particular the silhouette of the motor vehicle, is influenced by the presence of such airfoil or airfoil assemblies. Such airfoils or spoilers are normally firmly mounted or movably mounted to the motor vehicle. Depending on the travel situation or requirements at hand, a tilt of the airfoil and thus the angular disposition of the airfoil can also be modified in order to influence the airflow around the motor vehicle and the aerodynamics thereof.

In particular in connection with sport utility vehicles (SUV) and motor vehicles with similar silhouette, flow separation may be encountered in the region of the rear window, in particular in the region of the middle rear window. One approach to address this problem involves the use of window-fixed airfoils to counteract these flow separations. This is, however, disadvantageous because the presence of such window-fixed airfoils interferes with the viewing field of the driver through the rear window. For that reason, and also in view of the thus resultant silhouette of the motor vehicle, customers have heretofore rejected this approach.

It would therefore be desirable and advantageous to provide an improved motor vehicle to obviate prior art shortcomings and to prevent the occurrence of flow separation at the rear window while still exhibiting a pleasing visual look.

### SUMMARY OF THE INVENTION

According to one aspect of the present invention, a motor vehicle includes an airfoil assembly arranged in a region of a rear window of the motor vehicle, the airfoil assembly including at least one airfoil, a guide arranged on a side of the rear window, and an actuator configured to move the at least one airfoil along the guide.

The present invention resolves prior art problems by rendering the airfoil movable along the rear window of the motor vehicle. The airfoil is coupled at the side of the rear window to a guide for movement there along. Thus, when the motor vehicle is at a standstill or travels at low speed, i.e. a situation in which the airfoil has negligible impact on the aerodynamics of the motor vehicle, the airfoil can assume a position, e.g. adjacent to the roof edge, that ensures a pleasing optical look. When the motor vehicle travels at greater speeds of above 80 km/h, the airfoil can move to a position in a region of the middle of the rear window to prevent the presence of flow separation in this region.

An airfoil of the motor vehicle according to the present invention can therefore be moved to any position along the guide to best suit any situation at hand. A flow separation, for example in the region towards the middle of the rear window, can be prevented by moving the airfoil at a speed that has been predefined beforehand along the rear window to the respective position. The airfoil is thus moved along the guide depending on the desired aerodynamics and thus into a position along the rear window of the motor vehicle.

According to another advantageous feature of the present invention, the at least one actuator can be arranged on the at least one airfoil. The actuator is thus integrated in the airfoil and moves together with the airfoil. Advantageously, the actuator is surrounded by the airfoil or covered by the airfoil. The optical look of the motor vehicle remains therefore unaffected by the presence of the actuator.

According to another advantageous feature of the present invention, the actuator can include a belt drive, an output shaft rotatably mounted on the airfoil, and a driveshaft connected to the output shaft via the belt drive. As an alternative, the actuator can include a toothed rack, which is arranged in the guide, and a driveable gear in mesh with the toothed rack. As a result, the drive can thus have a driveshaft on which a gear is arranged and directly meshes with the toothed rack that is arranged in the guide. The driveshaft of the actuator with the gear is thus directly operated by the actuator and moves the airfoil due to the engagement with the toothed rack that is arranged in the guide.

As an alternative, the driveshaft of the actuator can operate a belt drive which is in operative interaction with the output shaft. The output shaft, in turn, can have a gear in mesh with the toothed rack that is arranged in the guide.

According to another advantageous feature of the present invention, the airfoil assembly can include two guides which are disposed in opposing relationship and arranged on opposite sides on the rear window. The provision of two opposite guides ensures an even and reliable guidance of the airfoil. Depending on the actuator used or on the arrangement of the actuator on the airfoil, the guides can be arranged on the rear window such that both guides oppose one another or that the openings of the guides point upwards, when viewed from the rear window.

According to another advantageous feature of the present invention, a holding element may be guided in the guide for movement along the guide for connection of the airfoil with the guide. The holding element engages the guide and secures the airfoil in the direction perpendicular to the rear window. Of course, the airfoil is still movable in the direction of the guide. The holding element may have an undercut which engages the guide, e.g. in the form of a groove thereof. The holding element may hereby engage the guide without touching the toothed rack arranged in the guide. The gear, which meshes inside the guide with the toothed rack, may, for example, have a grater radius that the holding element so as to mesh with the toothed rack. As an alternative, the holding element may also have an L-shaped cross section and engage the guide without touching the toothed rack. Of course, more than one holding element may be arranged on the airfoil for each guide. In particular, provision may be made for engagement of a holding element before and after the gear into the guide, as viewed in movement direction of the airfoil along the guide.

According to another advantageous feature of the present invention, the actuator can be connected to two gears which respectively mesh with the toothed racks arranged in the guide. The actuator may thus include two output shafts, for example, which have each a gear. Each of the gears meshes with one of the toothed racks arranged in the guides. This advantageously prevents a jamming of the airfoil between the two guides, because the output shafts, which each carry a gear, are arranged on the same actuator and thus operated in synchronism.

According to another advantageous feature of the present invention, the airfoil assembly can include actuators which are each connected to a gear, with the gears meshing respective toothed racks in the guide. Thus, two actuators may be arranged on the airfoil, for example at the ends of the airfoil or any other specified positions on the airfoil. Each actuator drives a driveshaft which has a gear in mesh with one of the toothed racks arranged in the guides. Of course, it is also possible to configure the two actuators in accordance with the afore-described alternative in the form of one actuator with driveshaft to drive an output shaft with gear via a belt drive.

According to another advantageous feature of the present invention, the actuators can be coupled to one another or driven in synchronism. A control device may hereby be used to ensure that the two actuators are operated in synchronism. As an alternative, a mechanical coupling for example may be provided to ensure a same operation of the actuators. Jamming or inadvertent tilting of the airfoil can advantageously be avoided between the two guides.

According to another advantageous feature of the present invention, the airfoil assembly can include a tilt adjuster configured to modify a tilt of the at least one airfoil about a transverse axis of the motor vehicle. The angle between the rear window and the at least one airfoil can thus be altered with the use of the tilt adjuster. As a result, the airfoil may intervene more vigorously in the way air flows around the motor vehicle or moved further in the direction of the rear window. The presence of the tilt adjuster enables therefore to directly influence aerodynamics of the motor vehicle.

According to another advantageous feature of the present invention, the airfoil assembly can include a length adjuster configured to extend or shorten a length of the airfoil in a direction of a free end of the airfoil. The length adjuster and/or the airfoil include hereby for example a telescoping structure by which the length adjuster that is coupled to the airfoil can move the airfoil out and in to extend or shorten the airfoil in the direction of its free end.

It is, of course, also conceivable to use more than one tilt adjuster and/or length adjuster on the airfoil assembly of the motor vehicle according to the invention.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a side view of a motor vehicle according to the present invention having incorporated therein the subject matter of the invention;

FIG. 2 is an enlarged cutaway view of the motor vehicle of FIG. 1 in a region of the rear window;

FIG. 3 is another enlarged cutaway view of the motor vehicle of FIG. 1 in a region of the rear window;

FIG. 4 is an enlarged detailed perspective view of a first exemplary embodiment of an airfoil assembly of the motor vehicle according to the present invention; and

FIG. 5 is an enlarged detailed view of a second exemplary embodiment of an airfoil assembly of the motor vehicle according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

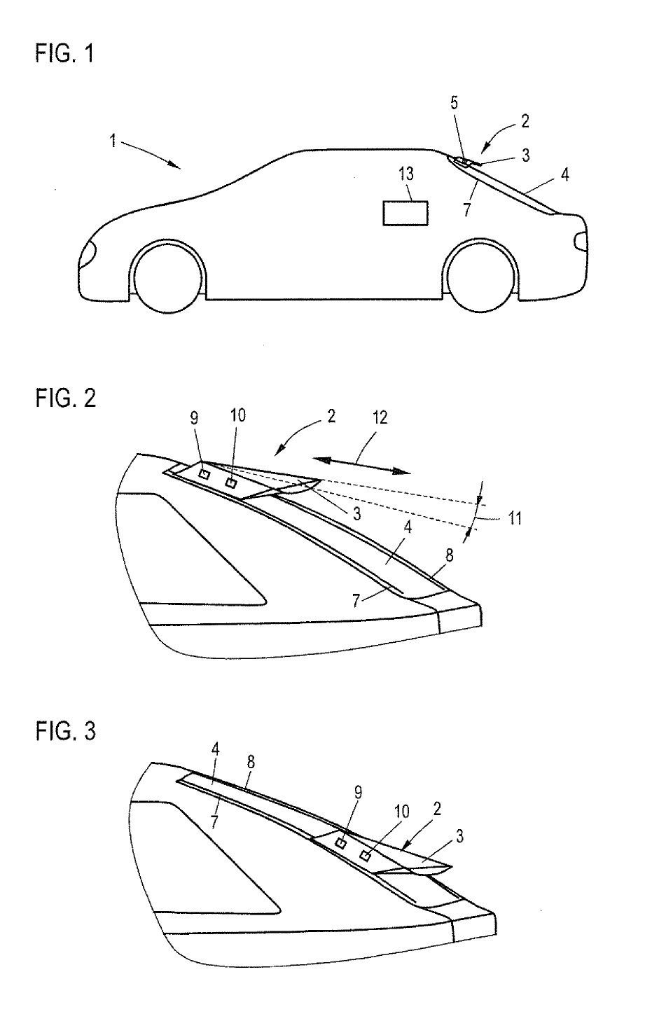

Turning now to the drawing, and in particular to FIG. 1, there is shown a side view of a motor vehicle according to the present invention, generally designated by reference numeral 1. The motor vehicle 1 includes an airfoil assembly, generally designated by reference numeral 2 and arranged in a region of a rear window 4 of the motor vehicle 1. The airfoil assembly 2 includes an airfoil 3 which is movable by actuators 5, 6 along guides 7, 8 which are arranged laterally on the rear window 4 of the motor vehicle, as best seen by way of example in FIG. 5. The guides 7, 8 exₜend in parallel relation to the rear window 4 of the motor vehicle 1, as will be described hereinafter in greater detail with reference to FIGS. 3-5. Advantageously, the guides 7, 8 are arranged at the lateral edges of the rear window 4. In the exemplary embodiment of the motor vehicle 1, shown here, the rear window 4 is bounded by two columns of the body of the motor vehicle 1, with the guides 7, 8 being arranged on the columns, respectively. The columns may hereby involve, by way of example, the C column or D column of the motor vehicle 1. As is readily apparent, the course of the guides 7, 8 is primarily dependent on the curvature profile of the rear window 4 since the guide 7, 8 are arranged, as described above, on the rear window 4 or on the part of the motor vehicle body that bounds the rear window 4.

FIG. 2 shows an enlarged cutaway view of the motor vehicle 1 of FIG. 1 in a region of the rear window 4. For ease of illustration, the actuators 5, 6 have been omitted here and the guides 7, 8 are depicted only as lines. The airfoil 3 includes a tilt adjuster 9 and a length adjuster 10. The tilt adjuster 9 is configured for tilting the airfoil 3 about the transverse axis of the motor vehicle 1. This is illustrated by double arrow 11 which indicates that the airfoil 3 can be tilted for example in relation to the horizontal or in relation to the curvature of the rear window 4.

The length adjuster 10 is configured to lengthen or shorten a length of the airfoil 3 in the direction of the free end of the airfoil 3. This is illustrated by double arrow 12.

The actuators 5, 6, the tilt adjuster 9, and the length adjuster 10 can be controlled by a control device 13, as shown in FIG. 1. Thus, any tilt of the airfoil 3 as well as any length and any position of the airfoil 3 along the guide 7, 8, which extend along the rear window 4, can thus be adjusted. For this purpose, the control device 13 generates corresponding signals for the final control element, i.e. actuators 5, 6, tilt adjuster 9, and length adjuster 10.

FIG. 2 shows the airfoil 3 in a position, when the motor vehicle 1 is at a standstill or travels at low speeds. In this speed range, e.g. 0 to 50 km/h, especially 0 to 80 km/h, any change in the air flow around the motor vehicle 1, as caused by the airfoil 3, is negligible. In this speed range, the optical look of the motor vehicle 1 or its silhouette is important in terms of positioning the airfoil 3 along the rear window 4 of the motor vehicle. Thus, the airfoil 3 assumes the uppermost end position adjacent to the roof edge of the motor vehicle 1. Both tilt and length of the airfoil 3 can be best suited, as desired, or in accordance with a set operating mode of the motor vehicle 1. When selecting for example a sporty travel setting or sporty operating mode of the motor vehicle 1, the airfoil 3 may be extended and the tilt of the airfoil 3 increased to realize a sporty silhouette of the motor vehicle 1.

FIG. 3 shows another enlarged cutaway view of the motor vehicle of FIG. 1 in a region of the rear window 4. FIG. 3 shows a state in which the motor vehicle 1 travels at a speed range of above 80 km/h, for example. To prevent flow separation or flow breakup in the region of the rear window 4 of the motor vehicle 1, the airfoil 3 has been moved downwards by about two thirds of the length of the rear window 4. Depending on the travel situation at hand, tilt and length can be influenced by the tilt adjuster 9 and the length adjuster 10, respectively. Thus, the separation edge can be randomly adjusted. It is, of course, also possible, to adjust the airfoil 3 also in any of the other speed ranges, even at standstill, to assume the position shown in FIG. 3.

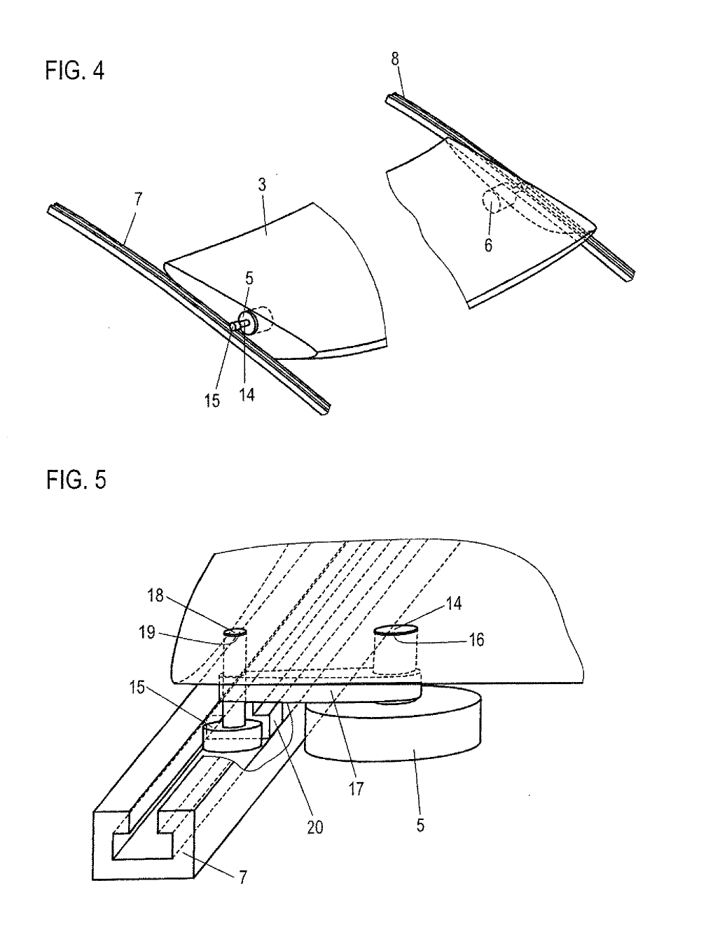

FIG. 4 shows an enlarged detailed perspective view of a first exemplary embodiment of an airfoil assembly 2 of the motor vehicle 1 according to the present invention, depicting in particular the actuators 5, 6. For ease of illustration, FIG. 4 indicates only toothed racks arranged in the guides 7, 8. In this embodiment, the actuators 5, 6 are arranged to the side of the airfoil 3, in particular integrated therein. The actuators 5, 6 have each a driveshaft 14 having a gear 15. The gears 15 of the actuators 5, 6 are in mesh with toothed racks that are arranged in the guides 7, 8, respectively. Activation of the actuators 5, 6 causes the driveshafts 14 and the attached gears 15 to rotate, with the gears 15 meshing with the toothed racks, arranged in the guide 7, 8. The airfoil 3 is thus moved along the rear window 4 in response to the rotation direction of the actuators 5, 6. In the exemplary embodiment shown here, the actuators 5, 6 are controlled by the control device 13 and moved in synchronism. Although not shown in greater detail, the actuators 5,6 are advantageously supplied with energy by elements that are integrated in the guides 7, 8.

In the exemplified embodiment of the airfoil assembly 2 in FIG. 4, the guides 7, 8 are arranged opposite to one another. The openings in the guides 7, 8 thus point substantially in the direction of the center of the rear window 4, i.e. towards the airfoil 3. The driveshafts 14 of the actuators 5, 6, which are firmly connected to the airfoil 3, project from the side of the airfoil 3 into the guides 7, 8.

FIG. 5 shows an enlarged detailed view of a second exemplary embodiment of an airfoil assembly 2 of the motor vehicle 1 according to the present invention. Parts corresponding with those in FIG. 4 are denoted by identical reference numerals and not explained again. In this embodiment, the actuators 5, 6 are each supported in a recess 16 in the airfoil 3. For convenience and ease of illustration, the following description is made only in relation to the left-hand side of the airfoil assembly 2, as viewed in travel direction of the motor vehicle 1, when in fact the two sides of the airfoil assembly 2 are mirror images of one another about an imaginary vertical medial plane which bisects the left from the right of the airfoil assembly 2. Thus, although the airfoil assembly 2 will be described with respect to only one side of the airfoil assembly 2, it will be understood that the same components of the airfoil assembly 2 are duplicated on the opposite side of the airfoil assembly 2.

The actuator 5 has a driveshaft 14 which, in this embodiment, is not directly connected to the gear 15. The driveshaft drives a belt 17 which, in turn, is connected to an output shaft 18, arranged in a recess 19 in the airfoil 3. Both the driveshaft 14 and the output shaft 18 are, of course, rotatably mounted in the respective recesses 16 and 19 in the airfoil 3. The output shaft 18 has an end which is in engagement with the guide 7 and carries a gear 15 in mesh with a not shown toothed rack, arranged in the guide 7. Thus, rotation of the driveshaft 14 can be transmitted via the belt drive 17 onto the output shaft 18, causing the airfoil 3 to move along the guide 7 along the rear window 4 of the motor vehicle 1 as a result of the meshed connection of the gear 15 inside the guide 7 with the toothed rack.

As is further apparent from FIG. 5, the airfoil 3 includes a holding element 2 having a substantially T shaped cross section, The T shaped cross section engages in the groove of the guide 7 to thereby hold the airfoil 3 in place in the guide 7. Of course, the holding element 20 is movable along the guide 7.

Activation of the actuator 5 and of course also of the not shown actuator 6 is again realized by the control device 13 so that the actuators 5, 6 operate in synchronism.

In both exemplary embodiments shown in FIGS. 4 and 5, the actuators 5, 6, are configured with a self-locking effect in the absence of a current, so that the airfoil 3 cannot move, when the actuators 5, 6 are currentless. As a result, any movement of the airfoil 3 may only be implemented by the actuators 5, 6.

Of course, it is possible to combine the actuators 5, 6 in any of the described embodiments with holding elements 20, as shown in FIG. 5. For this purpose, it is only required to turn the guide 7, 8 by 90° and to arrange the holding elements 20 at corresponding positions on the airfoil 3.

It is, of course, also possible to combine the tilt adjuster 9 and the length adjuster 10 in any desired fashion with the two embodiments of the actuators 5, 6, as shown in FIGS. 4 and 5.

The openings of the guides 7, 8 may further be provided with a sheet for example to cover the openings and to bear in the region of the driveshaft 14, output shaft 18, and holding elements 20, respectively, upon these components. This has the advantage of preventing any foreign matter to migrate into the guides 7, 8 while ensuring a pleasing look since mechanical parts, like for example the toothed rack, become invisible.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A motor vehicle, comprising an airfoil assembly arranged in a region of a rear window of the motor vehicle, said airfoil assembly including at least one airfoil, a guide arranged on a side of the rear window, and an actuator configured to move the at least one airfoil along the guide.

2. The motor vehicle of claim 1, wherein the at least one actuator is arranged on the at least one airfoil.

3. The motor vehicle of claim 1, wherein the actuator includes a belt drive, an output shaft rotatably mounted on the airfoil and having a gear, a driveshaft connected to the output shaft via the gear and the belt drive.

4. The motor vehicle of claim 1, wherein the airfoil assembly includes a toothed rack arranged in the guide, said actuator including a driveable gear in mesh with the toothed rack.

5. The motor vehicle of claim 1, wherein the airfoil assembly includes two of said guide disposed in opposing relationship and arranged on opposite sides on the rear window.

6. The motor vehicle of claim 1, further comprising a holding element guided in the guide for movement along the guide, said holding element connecting the airfoil with the guide.

7. The motor vehicle of claim 4, wherein the airfoil assembly includes two of said guide, two of said toothed rack arranged in the guides in one-to-one correspondence, and two gears, said actuator being connected to the gears.

8. The motor vehicle of claim 4, wherein the airfoil assembly includes two of said actuator, two of said guide, two of said toothed rack arranged in the guides in one-to-one correspondence, and two gears in mesh with the toothed racks in one-to-one correspondence, said actuators being connected to the gears in one-to-one correspondence.

9. The motor vehicle of claim 8, wherein the actuators are coupled to one another or driven in synchronism.

10. The motor vehicle of claim 1, wherein the airfoil assembly includes a tilt adjuster configured to modify a tilt of the at least one airfoil about a transverse axis of the motor vehicle.

11. The motor vehicle of claim 1, wherein the airfoil assembly includes a length adjuster configured to extend or shorten a length of the airfoil in a direction of a free end of the airfoil.
